(19) United States
(12) Patent Application Publication
(10) Pub. No.: US 2025/0038811 A1
(43) Pub. Date: Jan. 30, 2025

(54) NETWORK-SIDE ARTIFICIAL INTELLIGENCE (AI) / MACHINE LEARNING (ML) MODEL MONITORING

(71) Applicant: MEDIATEK INC., Hsinchu (TW)

(72) Inventors: Pedram Kheirkhah Sangdeh, San Jose, CA (US); Jie-Ni Liang, Hsinchu (TW); Gyu Bum Kyung, San Jose, CA (US)

(21) Appl. No.: 18/780,808

(22) Filed: Jul. 23, 2024

Related U.S. Application Data
(60) Provisional application No. 63/515,141, filed on Jul. 24, 2023.
(60) Provisional application No. 63/515,606, filed on Jul. 26, 2023.

(51) Int. Cl. H04B 7/06; H04W 24/02

(52) U.S. Cl. CPC H04B 7/0626; H04W 24/02

(57) ABSTRACT

In an aspect of the disclosure, a method, a computer-readable medium, and an apparatus are provided. The apparatus may be a base station. The base station receives a sounding reference signal (SRS) from a user equipment (UE). The base station estimates an uplink (UL) channel state information (CSI) based on the received SRS. The base station monitors the estimated UL CSI to track changes. The base station determines whether to update or switch an artificial intelligence (AI)/machine learning (ML) model used for downlink (DL) CSI compression based on the monitoring of the estimated UL CSI.

### CROSS-REFERENCE TO RELATED APPLICATION(S)

This application claims the benefits of U.S. Provisional Application Ser. No. 63/515,141, entitled “METHOD AND APPARATUS FOR NETWORK-SIDE DATA COLLECTION” and filed on Jul. 24, 2023 and U.S. Provisional Application Ser. No. 63/515,606, entitled “METHOD AND APPARATUS FOR NETWORK-SIDE ARTIFICIAL INTELLIGENCE (AL)/MACHINE LEARNING (ML) MODEL MONITORING” and filed on Jul. 26, 2023, both of which are expressly incorporated by reference herein in their entirety.

### BACKGROUND

### Field

The present disclosure relates generally to wireless communications, and more particularly, to techniques of monitoring the performance and applicability of Artificial Intelligence (AI) or Machine Learning (ML) models used for downlink (DL) Channel State Information (CSI) compression in wireless communication systems.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus is provided. The apparatus may be a base station. The base station receives a sounding reference signal (SRS) from a user equipment (UE). The base station estimates an uplink (UL) channel state information (CSI) based on the received SRS. The base station monitors the estimated UL CSI to track changes. The base station determines whether to update or switch an artificial intelligence (AI)/machine learning (ML) model used for downlink (DL) CSI compression based on the monitoring of the estimated UL CSI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a Channel State Information (CSI) compression process using an Artificial Intelligence/Machine Learning (AI/ML) model.

FIG. 8 is a diagram illustrating a Frequency Division Duplex (FDD) system.

FIG. 9 is a diagram illustrating direct monitoring of UL CSI by a base station.

FIG. 10 illustrates a hypothetical autoencoder-based monitoring framework for monitoring performance and applicability of the AI/ML model used for CSI compression.

FIG. 11 is a diagram illustrating two possible configurations of a hypothetical autoencoder used in a monitoring unit for assessing performance and applicability of the AI/ML model used for CSI compression.

FIG. 12 is a flow chart of a method for monitoring performance of an AI/ML model.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

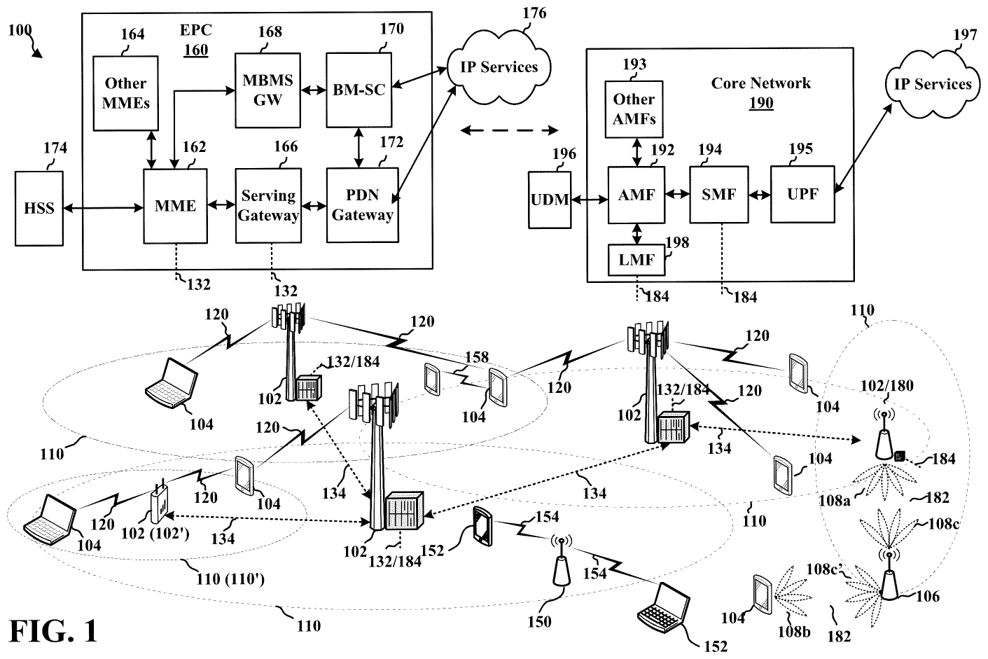

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR. The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

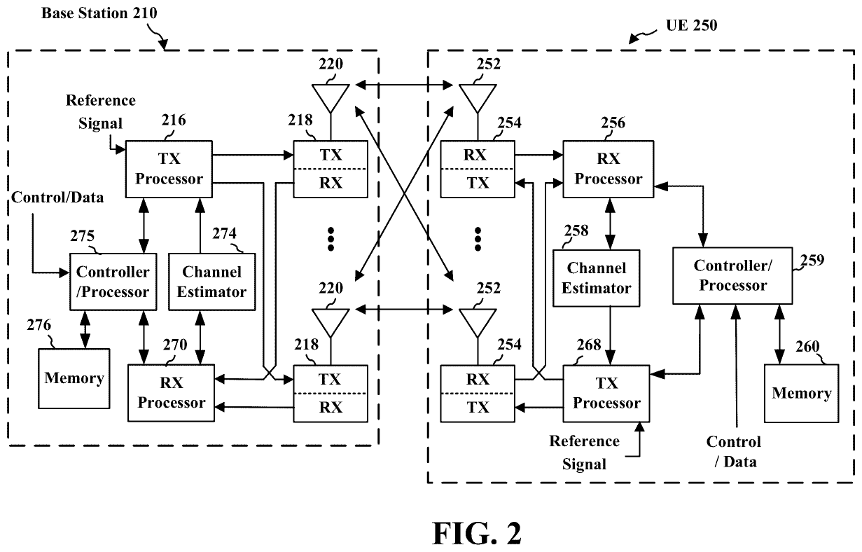

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

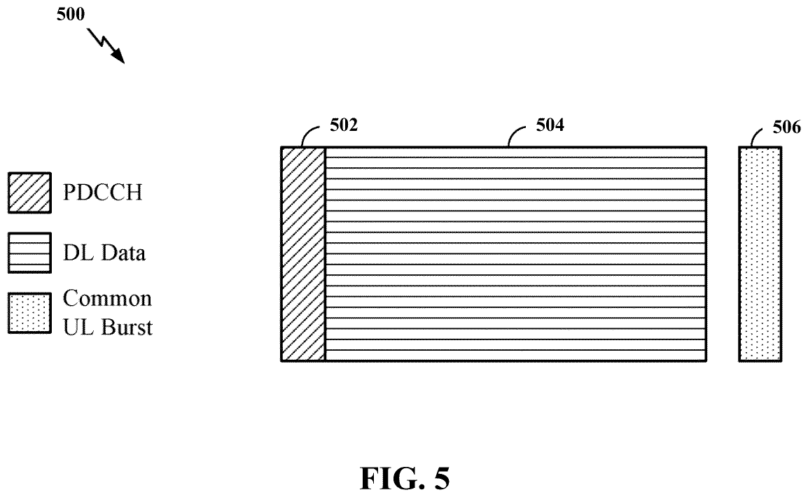

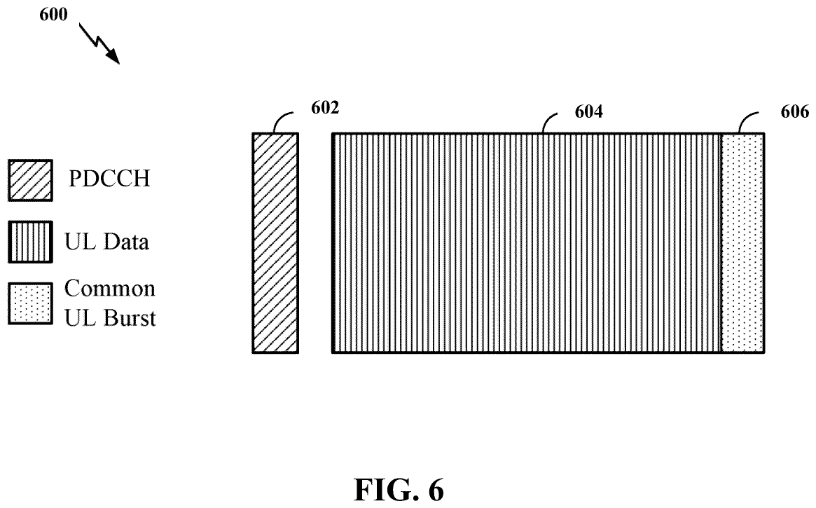

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

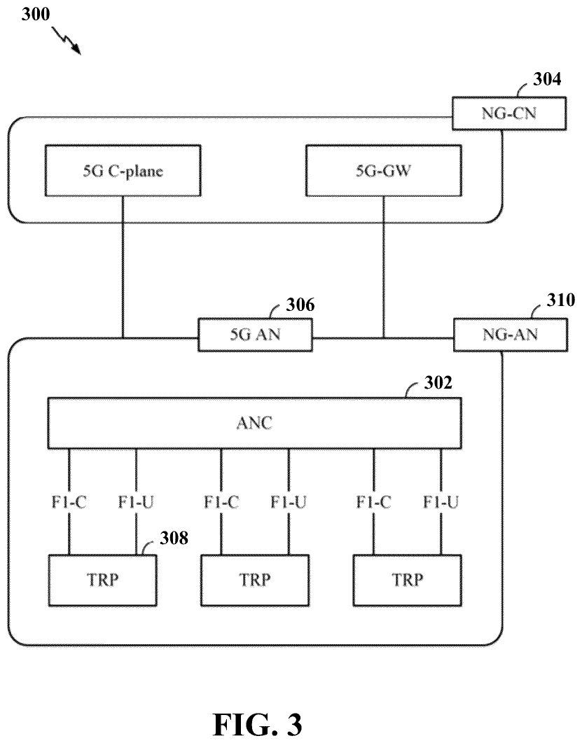

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

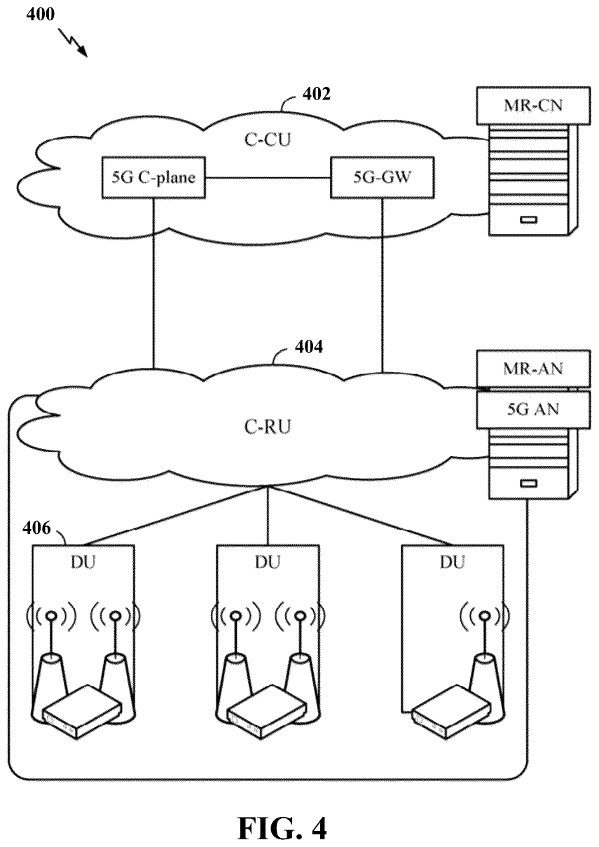

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

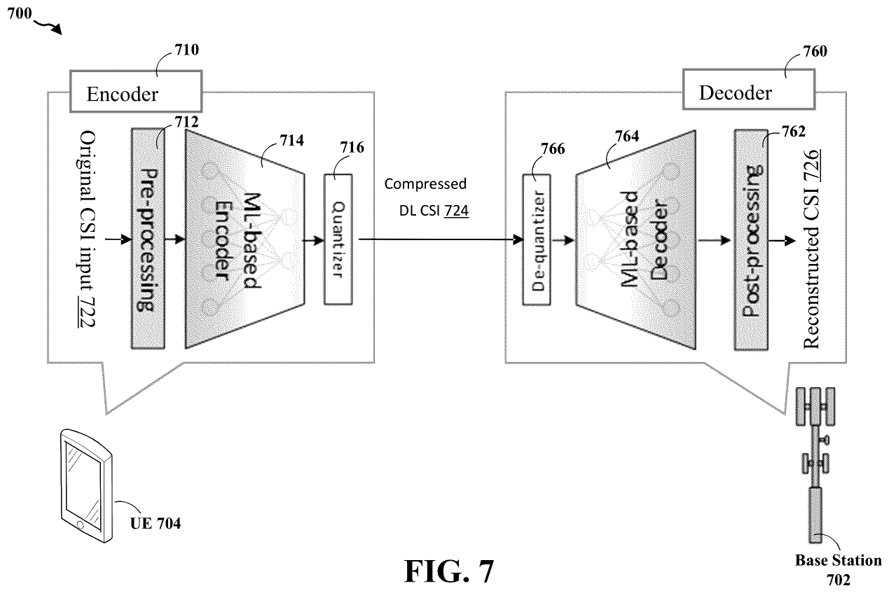

FIG. 7 is a diagram 700 illustrating a Channel State Information (CSI) compression process using an Artificial Intelligence/Machine Learning (AI/ML) model. In this example, a UE 704 includes an encoder module 710 that compresses a DL CSI 722, which is then transmitted to a base station 702. The base station 702 includes a decoder module 760 that decompresses compressed DL CSI 724 to produce a reconstructed DL CSI 726. The base station 702 may have the same physical structure as that of the base station 210. The UE 704 may have the same physical structure as that of the UE 704.

The UE 704 obtaining derives original DL CSI 722 from measurements of the CSI Reference Signals (CSI-RS). The original DL CSI 722 is then fed into a pre-processing component 712 within the encoder module 710. The pre-processing stage may involve operations such as the extraction of the precoding vector and other operations that do not alter the spatial information of the precoding vector. For example, if all vectors are rotated together, this rotation does not affect the spatial information. As another example, interleaving the vectors of the precoding matrix H does not affect the spatial information.

After pre-processing, the data is fed into an ML-based encoder 714. This encoder is part of a two-sided AI/ML model specifically trained for the CSI compression task. The encoder translates the pre-processed CSI into a compressed representation. There are different types of ML models that can be used for this encoding process, such as convolutional models that operate in the beam delay domain or transformer models that work directly on the antenna and frequency data.

The output of the ML-based encoder 714 is a latent representation of the compressed DL CSI 724. This latent representation may a vector with a predefined dimension, typically much shorter than the input CSI. For example, if the input to the ML-based encoder 714 is a 32 by 32 matrix of complex numbers, the output latent representation could be a vector with 28, 52, or 56 elements. This compression reduces the amount of data that needs to be transmitted from the UE 704 to the base station 702.

The latent representation is then quantized by the quantizer 716 to convert it into a format suitable for transmission over the air interface. The compressed and quantized CSI, referred to as compressed DL CSI 724, is sent as feedback from the UE 704 to the base station 702, reducing the air time required for transmission compared to sending the uncompressed CSI.

At the base station 702, the compressed DL CSI 724 is received by the de-quantizer 766, which converts it back into the latent representation. The latent representation is then input into the ML-based decoder 764, which reconstructs the CSI from the compressed representation. This reconstruction process is the reverse of the encoding process. The post-processing component 762 performs the inverse operations of the pre-processing component 712, such as converting the CSI back to the antenna and frequency domain if necessary. The output of the post-processing component 762 is reconstructed DL CSI 726, which should be similar to the original DL CSI 722 input into the encoder module 710.

The encoder module 710 and decoder module 760 are trained for specific scenarios, configurations, and environments represented by the training dataset. For example, the models can be trained for a specific number of antennas, carrier frequency, and indoor or outdoor environments. The trained models work well in the environment they were trained for. For instance, the training data might include scenarios with 16 antennas and a carrier frequency of 10 MHz in an indoor environment. In such a case, the model is trained using data collected from this specific environment, resulting in a model that performs well under these conditions. However, if the environment changes significantly, such as moving from a line-of-sight to a non-line-of-sight scenario or changing the carrier frequency, the performance of the model may degrade.

Further, the encoder module 710 and decoder module 760 may not be identical, as they can belong to different vendors. The two sides can cooperate without revealing information about their specific models, allowing for flexibility in the implementation of the CSI compression system.

Furthermore, the ML-based encoder 714 can use different types of layers and architectures to compress the CSI. Two popular approaches are convolutional models that operate in the beam delay domain and transformer models that work directly on the antenna and frequency data.

In the beam delay domain, there are sparse regions that indicate clusters and determine how the waves propagate to the receiver. This sparsity pattern provides information about the geometry of the environment. Convolutional models are well-suited for this domain because their kernels can search over different areas and capture relevant features. When using a convolutional model, the pre-processing component 712 may include a conversion to the beam delay domain, and the post-processing component 762 would revert the data back to the antenna and frequency domain.

Transformer models, on the other hand, can directly process the CSI in the antenna and frequency domain without requiring a conversion to the beam delay domain. These models rely on attention mechanisms to capture dependencies and extract relevant features from the input data.

The choice of the ML model architecture depends on the specific requirements and characteristics of the CSI compression task. Convolutional models can exploit the sparsity and geometric information in the beam delay domain, while transformer models can operate directly on the antenna and frequency data. The selected architecture should be trained on a dataset that represents the target scenario, configuration, and environment for optimal performance.

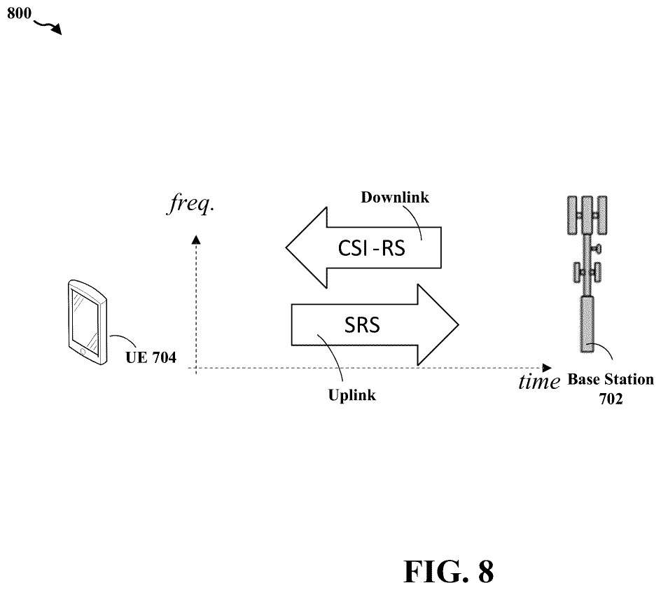

FIG. 8 is a diagram 200 illustrating a Frequency Division Duplex (FDD) system. In FDD systems, the uplink (UL) and downlink (DL) transmissions occur at different frequencies. Due to this frequency separation, there is a lack of full channel reciprocity between the UL and DL channels, i.e., H^{u}(f, t)≠H^{d}(f′, t), where H^{u} and H^{d} represent the UL and DL channel matrices, respectively, and f and f′ denote the different frequencies used for UL and DL transmissions. As a result, the UL CSI cannot be directly used for DL beamforming in FDD systems. Instead, the DL CSI needs to be estimated by the UE 704 using the CSI-RS and then fed back to the base station 702 for DL beamforming purposes.

Although the UL and DL channels in FDD systems are not exactly the same due to the frequency separation, they exhibit similar semantic features, such as large-scale channel characteristics. This similarity allows the AI/ML models used for CSI compression to be generalizable over different carrier frequencies. In other words, if an AI/ML model is trained on one carrier frequency, it can still perform well on other frequencies.

Given the similarity between the UL and DL channels, it is possible to use the UL CSI obtained from the Sounding Reference Signals (SRS) to track and monitor the changes in the DL CSI. If the AI/ML model is trained on both UL and DL CSI samples, it can capture the common semantic features between the two channels. Consequently, any significant changes in the RF environment that affect the DL CSI will also be reflected in the UL CSI. By monitoring the UL CSI, the base station 702 can infer the potential changes in the DL CSI and assess whether the current AI/ML model used for CSI compression remains applicable or needs to be updated.

This approach of using the UL CSI for tracking and monitoring purposes, rather than for actual CSI compression, allows the base station 702 to detect changes in the RF environment and make informed decisions about the validity and performance of the AI/ML model without requiring explicit feedback of the DL CSI from the UE 704. This monitoring mechanism can help reduce the overhead associated with frequent DL CSI feedback while still enabling the base station 702 to adapt the AI/ML model when necessary based on the observed changes in the UL CSI.

There are several NW-side solutions for monitoring the performance and applicability of the AI/ML models used for CSI compression. However, these solutions have certain shortcomings that need to be addressed.

One approach is system-level KPI monitoring, where the base station 702 monitors system-level indicators such as ACK/NACK rate, throughput, and Block Error Rate (BLER) to identify changes in the working RF environment of the AI/ML model, its failure, or malfunctioning. The main drawback of this method is that low performance or failure can be rooted in a harsh RF environment and not necessarily due to the model itself. This can lead to false alarms and unnecessary model updates.

Another approach is intermediate-KPI-based monitoring with target CSI transfer. In this method, the base station 702 monitors intermediate KPIs such as Generalized Cosine Similarity (GCS), Squared Generalized Cosine Similarity (SGCS), Normalized Mean Squared Error (NMSE), and Mean Squared Error (MSE) between the reconstructed DL CSI 726 (decoded from the compressed DL CSI 724 received from the UE 704) and the target/ground truth CSI. The UE 704 sends target CSI samples to the base station 702 along with the latent output of the encoder module 710, enabling the base station 702 to calculate the KPIs. However, this approach imposes an additional burden on the UE 704 to process and send the target CSI in a periodic or aperiodic manner, resulting in increased overhead due to the transmission of target DL CSI along with the latent representation.

A third approach is intermediate-KPI-based monitoring with UE's model transfer. In this method, the UE 704 sends its encoder module 710 to the base station 702 in a one-time action. For monitoring intermediate KPIs, the UE 704 sends the target CSI to the base station 702, which feeds it to the encoder and decoder modules to reconstruct the CSI. The base station 702 then keeps track of the intermediate KPIs between the target and reconstructed CSI. The main issues with this approach are that it violates the proprietary nature of the UE's AI/ML model, as the UE's AI/ML model architecture, complexity, and format may not be tailored for the base station 702. Additionally, it imposes extra computational and storage burden on the base station 702 and still requires the overhead of sending target DL CSI without the latent representation.

Lastly, the proxy encoder approach works similarly to the intermediate-KPI-based monitoring with UE's model transfer, but instead of having the UE's actual encoder at the base station 702, a proxy encoder (which is different and generally simpler than the actual encoder) is available at the base station 702. The intermediate KPI from the proxy autoencoder (proxy encoder-actual decoder) is a shifted version of the intermediate KPI from the actual autoencoder (actual encoder, actual decoder) and thus able to reflect any monitoring events that the actual KPI was able to show. However, this approach still incurs additional computational and storage burden on the base station 702 and requires the overhead of sending target DL CSI without the latent representation.

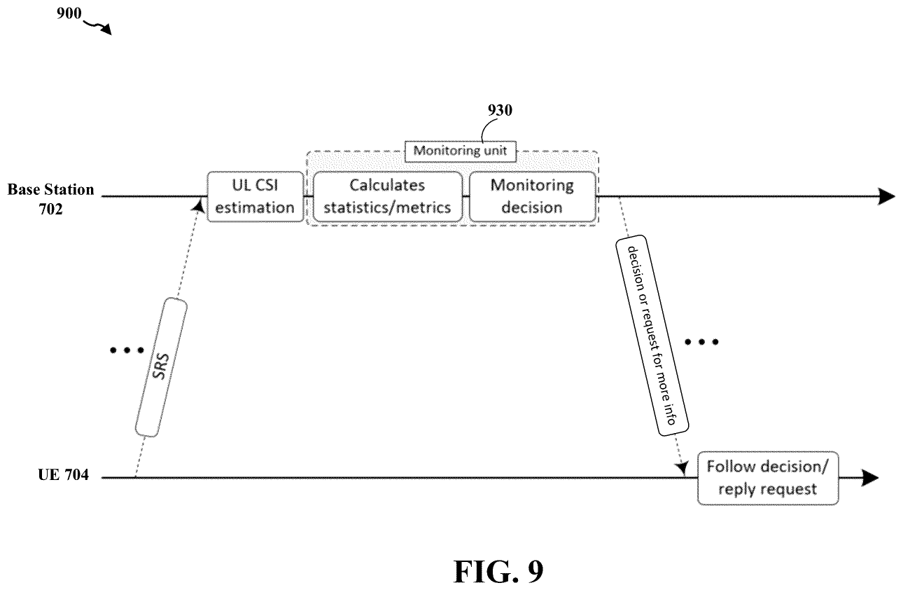

FIG. 9 is a diagram 900 illustrating direct monitoring of UL CSI by the base station 702. In this example, the base station 702 uses the channel reciprocity between the UL and DL channels to monitor the DL CSI using the UL CSI, without requiring the UE 704 to send the target DL CSI.

Initially, the UE 704 sends SRSs to the base station 702. Upon receiving the SRSs, the base station 702 estimates the UL CSI. The estimated UL CSI is then passed to a monitoring unit 930 within the base station 702.

The monitoring unit 930 calculates various statistics and metrics based on the UL CSI. These statistics may include historical mean, variance, and other relevant features of the UL CSI. By comparing the current UL CSI features with prior observations, the base station 702 can determine the extent of the changes in the RF environment. If the changes are significant and likely to impact the performance of the AI/ML model used for DL CSI compression, the base station 702 can take appropriate actions, such as deactivating the current model or switching to a more suitable one.

Additionally, the monitoring unit 930 may compute metrics such as historical entropy, Power Spectral Entropy (PSE), and distance from reference points.

As such, by analyzing the statistics and metrics derived from the UL CSI, the monitoring unit 930 makes a decision regarding the applicability and performance of the current AI/ML model used for CSI compression. This decision can involve maintaining the current model, activating alternative models, or reverting to a legacy approach. If the statistics and metrics indicate a significant change in the UL CSI compared to previous observations, it suggests that the current AI/ML model may no longer be suitable for the changed RF environment.

The monitoring unit 930 then sends its decision or a request for more information to the base station 702. The base station 702 forwards the decision or request to the UE 704. The UE 704 follows the decision or replies to the request accordingly.

The direct monitoring of UL CSI eliminates the need for the UE 704 to send the target DL CSI to the base station 702, reducing the overhead associated with the monitoring process. By using the channel reciprocity and the similarity between the UL and DL channels, the base station 702 can infer the changes in the DL CSI based on the observed changes in the UL CSI.

This approach may be particularly advantageous in FDD systems, where the UL and DL transmissions occur at different frequencies. Although the UL and DL channels are not exactly the same due to the frequency separation, they exhibit similar semantic features and large-scale channel characteristics. As a result, any significant changes in the RF environment that affect the DL CSI will also be reflected in the UL CSI.

The direct monitoring of UL CSI approach offers several benefits over existing NW-side monitoring solutions. It reduces the overhead associated with sending target DL CSI from the UE 704 to the base station 702 and eliminates the need for the UE 704 to process and send monitoring-specific information periodically. Additionally, it preserves the proprietary nature of the UE's AI/ML model, as the UE 704 is not required to share its model architecture or parameters with the base station 702.

As described supra, the monitoring unit 930 may directly monitor the statistics of the UL CSI to determine the performance and applicability of the AI/ML model used for CSI compression. The monitoring unit 930 within the base station 702 calculates various statistics based on the estimated UL CSI obtained from the SRSs sent by the UE 704. These statistics may include the maximum, mean, and variance of the different elements in the UL CSI matrix. By comparing the current statistics with previous observations, the monitoring unit 930 can determine the extent of the changes in the RF environment.

For example, let Hₜ^{u} denote the UL CSI matrix at time t, and let Hₜ₋₁^{u} denote the UL CSI matrix at the previous time step t−1. The monitoring unit 930 calculates the mean of the elements in Hₜ^{u} as follows:

$${μ}_{t} = \frac{1}{M N} {\sum }_{i = 1}^{M} {\sum }_{j = 1}^{N} {[ {H}_{t}^{u} ]}_{ij} ,$$

where M and N are the dimensions of the UL CSI matrix, and [Hₜ^{u}]ᵢⱼ represents the element at the i-th row and j-th column of Hₜ^{u}.

Similarly, the monitoring unit 930 calculates the variance of the elements in Hₜ^{u} as follows:

$${σ}_{t}^{2} = \frac{1}{M N} {\sum }_{i = 1}^{M} {\sum }_{j = 1}^{N} {( {[ {H}_{t}^{u} ]}_{i j} - {μ}_{t} )}^{2} .$$

The monitoring unit 930 then compares the current statistics μₜ and σₜ² with the previous statistics μₜ₋₁ and σₜ₋₁². If the difference between the current and previous statistics exceeds a predefined threshold, it indicates a significant change in the UL CSI, which suggests that the current AI/ML model may no longer be suitable for the changed RF environment.

Based on the comparison of the statistics, the monitoring unit 930 makes a decision regarding the applicability and performance of the current AI/ML model. If the statistics indicate a significant change in the UL CSI compared to previous observations, the monitoring unit 930 may decide to deactivate the current model and switch to a more suitable one or revert to a legacy approach.

In addition to monitoring the statistics of the UL CSI, the monitoring unit 930 may also calculate various metrics defined on the UL CSI to assess the performance and applicability of the AI/ML model used for CSI compression. These metrics provide a more comprehensive understanding of the changes in the RF environment and their potential impact on the AI/ML model.

One such metric is the historical entropy of the UL CSI. The monitoring unit 930 calculates the entropy of the current UL CSI matrix Hₜ^{u} and compares it with the entropy of the previous UL CSI matrices. In one example, the entropy of a matrix Hₜ^{u} is defined as:

$$E ( {H}_{t}^{u} ) = - {\sum }_{i = 1}^{M} {\sum }_{j = 1}^{N} {p}_{i j} {log}_{2} {p}_{ij} ,$$

where pᵢⱼ is the normalized magnitude of the element [Hₜ^{u}]ᵢⱼ, given by:

$${p}_{i j} = \frac{\vert {[ {H}_{t}^{u} ]}_{i j} \vert}{{Σ}_{i = 1}^{M} {Σ}_{j = 1}^{N} \vert {[ {H}_{t}^{u} ]}_{i j} \vert} .$$

The monitoring unit 930 tracks the historical entropy values and detects any significant changes. A sudden increase or decrease in the entropy compared to the historical values or predefined reference values indicates a change in the RF environment, which may affect the performance of the AI/ML model.

Another metric is the Power Spectral Entropy (PSE) of the UL CSI. The PSE measures the complexity and randomness of the power spectrum of the UL CSI. In one example, to calculate the PSE, the monitoring unit 930 first computes the power spectrum of the UL CSI matrix Hₜ^{u} using the Fourier transform:

$${P}_{t} = {\vert ℱ ( {H}_{t}^{u} ) \vert}^{2} ,$$

where [symbol] (⋅) denotes the Fourier transform operation. The PSE is then calculated as:

$$P S E ( {H}_{t}^{u} ) = - {\sum }_{i = 1}^{M} {\sum }_{j = 1}^{N} {\hat{p}}_{ij} {log}_{2} {\hat{p}}_{ij} ,$$

where \hat{p}ᵢⱼ is the normalized power spectrum coefficient, given by:

$${\hat{p}}_{i j} = \frac{{[ {P}_{t} ]}_{i j}}{{Σ}_{i = 1}^{M} {{Σ}_{j = 1}^{N} [ {P}_{t} ]}_{i j}} .$$

The monitoring unit 930 compares the current PSE value with the historical PSE values or predefined reference values. A significant change in the PSE indicates a change in the complexity and randomness of the UL CSI, which may suggest that the current AI/ML model is no longer suitable for the changed RF environment.

The monitoring unit 930 may also calculate the distance between the current UL CSI matrix Hₜ^{u} and a set of reference UL CSI matrices {H_{ref,1}^{u}, H_{ref,2}^{u}, . . . , H_{ref,K}^{u}}. These reference matrices represent typical or expected UL CSI patterns for different RF environments. The distance metric, such as Euclidean distance or cosine similarity, measures the similarity between the current UL CSI and the reference matrices. If the current UL CSI deviates significantly from the reference matrices, it indicates a change in the RF environment that may impact the performance of the AI/ML model.

For example, let d(Hₜ^{u}, H_{ref,k}^{u}) denote the Euclidean distance between the current UL CSI matrix Hₜ^{u} and the k-th reference matrix H_{ref,k}^{u}, given by:

$$d ( {H}_{t}^{u} , {H}_{ref , k}^{u} ) = \sqrt{{\sum }_{i = 1}^{M} {\sum }_{j = 1}^{N} {( {[ {H}_{t}^{u} ]}_{ij} - {[ {H}_{ref , k}^{u} ]}_{i j} )}^{2}} .$$

The monitoring unit 930 calculates the distances between the current UL CSI and all the reference matrices and compares them with predefined thresholds. If the distances exceed the thresholds, it suggests that the current UL CSI pattern is significantly different from the expected patterns, indicating a change in the RF environment.

By combining these metrics (historical entropy, PSE, and distance from reference points) with the statistical analysis of the UL CSI, the monitoring unit 930 can make a more informed decision about the applicability and performance of the AI/ML model used for CSI compression. If the metrics indicate a significant change in the UL CSI compared to the historical values or reference patterns, the monitoring unit 930 may decide to trigger further actions, such as updating the AI/ML model or switching to a fallback mechanism.

The use of these metrics provides a comprehensive approach to monitoring the UL CSI and detecting changes in the RF environment that may impact the performance of the AI/ML model. By using the channel reciprocity and the similarity between the UL and DL channels, the monitoring unit 930 can infer the potential changes in the DL CSI based on the observed changes in the UL CSI, without requiring the UE 704 to send the target DL CSI explicitly. This approach reduces the overhead associated with the monitoring process and enables the base station 702 to adapt the AI/ML model when necessary, based on the detected changes in the RF environment.

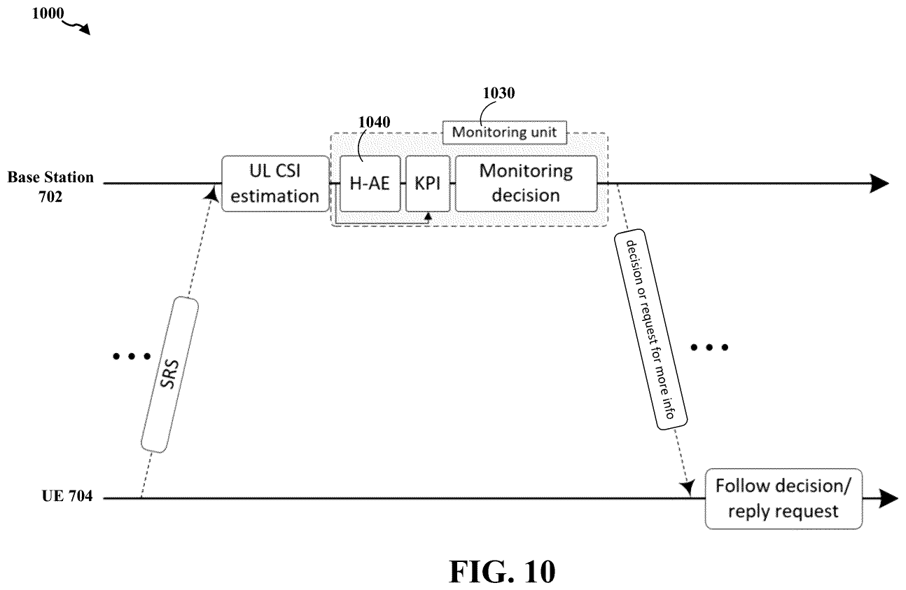

FIG. 10 illustrates a hypothetical autoencoder-based monitoring framework 1000 for monitoring the performance and applicability of the AI/ML model used for CSI compression. The monitoring unit 1030 within the base station 702 employs a hypothetical autoencoder 1040 to assess the quality of the UL CSI and make decisions regarding the validity of the current AI/ML model.

The monitoring framework consists of three main steps: data collection, inference using the hypothetical autoencoder (H-AE), and monitoring decision.

In the data collection step, the UE 704 sends SRS to the base station 702. The base station 702 estimates the UL CSI based on the received SRS. The estimated UL CSI is then passed to the monitoring unit 1030.

In the inference step, the monitoring unit 1030 feeds the UL CSI sample to the hypothetical autoencoder 1040. The hypothetical autoencoder 1040 compresses and decompresses the UL CSI sample, generating a reconstructed version of the UL CSI. The monitoring unit 1030 then calculates an intermediate Key Performance Indicator (KPI), such as Normalized Mean Squared Error (NMSE), Generalized Cosine Similarity (GCS), or Squared Generalized Cosine Similarity (SGCS), between the reconstructed UL CSI and the original UL CSI. This KPI reflects the reconstruction quality of the hypothetical autoencoder 1040 for the given UL CSI.

The hypothetical autoencoder 1040 serves as a proxy for the actual AI/ML model used for CSI compression. The hypothetical autoencoder 1040 was trained using UL CSI data that captures the underlying characteristics of the communication channel and collected over time, with the objective of reconstructing the input UL CSI accurately. The hypothetical autoencoder 1040 includes an encoder and a decoder, similar to the actual AI/ML model. However, the hypothetical autoencoder 1040 may have a different architecture or complexity compared to the actual AI/ML model, as it is designed specifically for monitoring purposes.

By comparing the input UL CSI to the hypothetical autoencoder 1040 and the reconstructed UL CSI output from the hypothetical autoencoder 1040, the monitoring unit 1030 can assess the performance of the hypothetical autoencoder 1040. If the intermediate KPI indicates a high similarity between the input and reconstructed UL CSI (e.g., low NMSE, high GCS or SGCS), it suggests that the hypothetical autoencoder 1040 is performing well and can accurately reconstruct the UL CSI. Consequently, it implies that the actual AI/ML model used for CSI compression is also likely to perform well in the current RF environment.

On the other hand, if the intermediate KPI indicates a significant difference between the input and reconstructed UL CSI (e.g., high NMSE, low GCS or SGCS), it suggests that the hypothetical autoencoder 1040 is struggling to reconstruct the UL CSI accurately. This implies that the actual AI/ML model may also face challenges in compressing and reconstructing the CSI in the current RF environment.

In the monitoring decision step, the monitoring unit 1030 makes a decision based on the intermediate KPI calculated in the inference step. The decision can be made by comparing the current KPI with historical KPI values or by setting a threshold for the KPI. If the current KPI deviates significantly from the historical values or falls below a predefined threshold, the monitoring unit 1030 may determine that a monitoring event has occurred, indicating a potential issue with the current AI/ML model.

Based on the monitoring decision, the monitoring unit 1030 can take subsequent actions, such as triggering a fallback mechanism, updating the AI/ML model, or sending a request for more information to the UE 704. The monitoring unit 1030 communicates its decision or request to the base station 702, which then forwards it to the UE 704. The UE 704 follows the decision or replies to the request accordingly.

The hypothetical autoencoder-based monitoring approach offers several advantages. Firstly, it eliminates the need for the UE 704 to send the target DL CSI to the base station 702, reducing the overhead associated with the monitoring process. Secondly, it preserves the proprietary nature of the UE's actual AI/ML model, as the UE 704 is not required to share its model architecture or parameters with the base station 702. The hypothetical autoencoder 1040 is trained and maintained by the base station 702 independently.

Furthermore, the hypothetical autoencoder-based monitoring uses the channel reciprocity and the similarity between the UL and DL channels to infer the performance of the actual AI/ML model used for DL CSI compression. By monitoring the UL CSI and assessing the reconstruction quality of the hypothetical autoencoder 1040, the monitoring unit 1030 can detect changes in the RF environment that may impact the performance of the actual AI/ML model.

The monitoring unit 1030 can also compare the current KPI with historical KPI values to identify any significant deviations or trends. If the current KPI consistently deviates from the historical values, it may indicate a gradual change in the RF environment that requires attention. The monitoring unit 1030 can use this information to proactively adapt the AI/ML model or trigger other necessary actions.

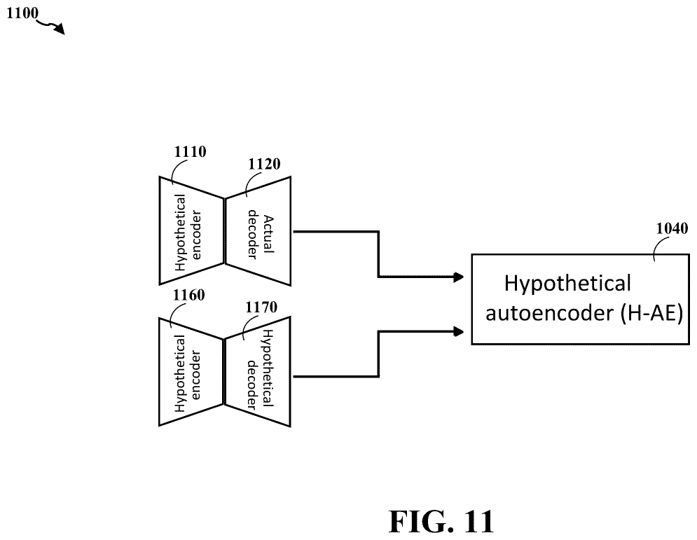

FIG. 11 is a diagram 1100 illustrating two possible configurations of the hypothetical autoencoder 1040 used in the monitoring unit 1030 for assessing the performance and applicability of the AI/ML model used for CSI compression.

In a first configuration, the hypothetical autoencoder 1040 includes a hypothetical encoder 1110 and the actual ML-based Decoder 764 used in the CSI compression process. The hypothetical encoder 1110 is trained to be compatible with the actual ML-based Decoder 764. This configuration allows the monitoring unit 1030 to assess the performance of the actual ML-based Decoder 764 when paired with a hypothetical encoder 1110 that is trained on UL CSI samples.

In the second configuration, the hypothetical autoencoder 1040 includes a hypothetical encoder 1160 and a hypothetical decoder 1170, both of which are trained specifically for monitoring purposes. This configuration provides more flexibility in the design and training of the hypothetical autoencoder 1040, as it is not constrained by the architecture or complexity of the actual decoder used in the CSI compression process.

The hypothetical autoencoder 1040 is trained using a dataset that includes UL CSI samples and, optionally, DL CSI samples. By training the hypothetical autoencoder 1040 on UL CSI samples, the monitoring unit 1030 can use the channel reciprocity and the similarity between the UL and DL channels to infer the performance of the actual AI/ML model used for DL CSI compression.

As described supra, during the inference stage, the hypothetical autoencoder 1040 is used to compress and decompress the UL CSI samples received from the base station 702. The monitoring unit 1030 calculates an intermediate Key Performance Indicator (KPI), such as Normalized Mean Squared Error (NMSE), Generalized Cosine Similarity (GCS), or Squared Generalized Cosine Similarity (SGCS), between the reconstructed UL CSI and the original UL CSI. This KPI can indicate performance of the actual AI/ML model used for CSI compression.

In certain configurations, the base station 702 may use a hybrid monitoring approach that combines UL CSI-based monitoring with DL CSI-based monitoring to achieve accurate and efficient monitoring of the AI/ML model used for CSI compression. The hybrid approach may enjoy the advantages of both UL CSI-based and DL CSI-based monitoring methods while mitigating their limitations.

The DL CSI-based monitoring methods, such as KPI-based monitoring with model transfer, KPI-based monitoring with target CSI transfer, and proxy encoder-based monitoring, are dedicated approaches for monitoring the performance and applicability of the AI/ML model using the DL CSI. These methods can potentially provide higher accuracy compared to UL CSI-based methods since they directly assess the model's performance on the DL CSI. However, the periodic and persistent usage of DL CSI-based methods comes with large overhead and computational burden.

On the other hand, UL CSI-based monitoring methods, such as input-based monitoring and hypothetical autoencoder-based monitoring, uses the channel reciprocity and the similarity between the UL and DL channels to infer the performance of the AI/ML model using the UL CSI. These methods have the advantage of reduced overhead and computational complexity since they do not require the explicit transmission of DL CSI from the UE 704 to the base station 702. However, UL CSI-based methods may have limitations in terms of accuracy compared to DL CSI-based methods.

The hybrid monitoring approach aims to achieve the optimal results by triggering the DL CSI-based monitoring methods only when necessary, based on the monitoring events detected by the UL CSI-based monitoring methods. The base station 702 uses the UL CSI-based monitoring methods as an initial stage to detect potential issues or changes in the RF environment that may affect the performance of the AI/ML model. When a monitoring event is detected by the UL CSI-based methods, it triggers the execution of the more accurate but computationally expensive DL CSI-based monitoring methods.

By adopting this hybrid approach, the monitoring system can benefit from the efficiency of UL CSI-based methods while still having the option to resort to the more accurate DL CSI-based methods when needed. This selective triggering of DL CSI-based methods reduces the overall overhead and computational burden associated with persistent monitoring using DL CSI.

While DL CSI-based monitoring methods are generally expected to provide higher accuracy compared to UL CSI-based methods, they may not always offer superior accuracy in practice. This is because, unlike UL CSI reporting, DL CSI is often quantized and partially reported to the base station 702. Additionally, the CSI estimation algorithms employed by the UE 704 are typically lightweight and simpler compared to those used in the base station 702. These factors can limit the accuracy gains of DL CSI-based methods over UL CSI-based methods.

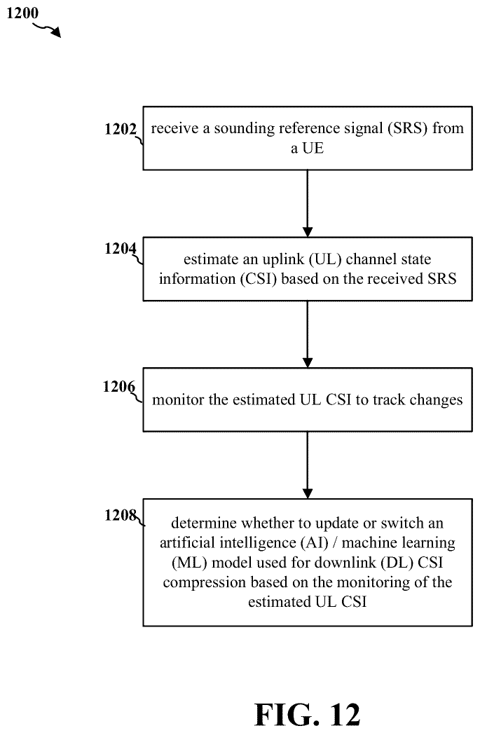

FIG. 12 is a flow chart 1200 of a method for monitoring performance of an AI/ML model. The method may be performed by a base station (e.g., the base station 702). In operation 1202, the base station receives a sounding reference signal (SRS) from a UE. In operation 1204, the base station estimates an uplink (UL) channel state information (CSI) based on the received SRS. In operation 1206, the base station monitors the estimated UL CSI to track changes. In operation 1208, the base station determines whether to update or switch an artificial intelligence (AI)/machine learning (ML) model used for downlink (DL) CSI compression based on the monitoring of the estimated UL CSI.

In certain configurations, to monitor the estimated UL CSI, the base station calculates one or more statistics of the estimated UL CSI. These statistics may include at least one of a mean of elements in the estimated UL CSI and a variance of elements in the estimated UL CSI. The base station then compares the calculated one or more statistics to one or more previous statistics of a previously estimated UL CSI. If a difference between the calculated one or more statistics and the one or more previous statistics exceeds a predefined threshold, the base station determines that the AI/ML model is to be updated or switched.

In certain configurations, to monitor the estimated UL CSI, the base station calculates one or more metrics based on the estimated UL CSI. These metrics may include at least one of a historical entropy of the estimated UL CSI, a power spectral entropy of the estimated UL CSI, or a distance between the estimated UL CSI and one or more reference UL CSIs. The base station then compares the calculated one or more metrics to one or more previous metrics of a previously estimated UL CSI or one or more reference metrics. If a difference between the calculated one or more metrics and the one or more previous metrics or reference metrics exceeds a predefined threshold, the base station determines that the AI/ML model is to be updated or switched.

In certain configurations, to monitor the estimated UL CSI, the base station inputs the estimated UL CSI into a hypothetical autoencoder to generate a reconstructed UL CSI. The hypothetical autoencoder may comprise a hypothetical encoder and a hypothetical decoder, or a hypothetical encoder and an actual decoder used in CSI compression. The base station then calculates a key performance indicator (KPI) based on the estimated UL CSI and the reconstructed UL CSI. The KPI may include at least one of a normalized mean squared error (NMSE) between the estimated UL CSI and the reconstructed UL CSI, a generalized cosine similarity (GCS) between the estimated UL CSI and the reconstructed UL CSI, or a squared generalized cosine similarity (SGCS) between the estimated UL CSI and the reconstructed UL CSI. If the calculated KPI falls below a predefined threshold, the base station determines that the AI/ML model is to be updated or switched.

In certain configurations, if the AI/ML model is to be updated or switched based on the monitoring of the estimated UL CSI, the base station triggers a DL CSI-based monitoring. The DL CSI-based monitoring may comprise at least one of a key performance indicator (KPI)-based monitoring with model transfer, a KPI-based monitoring with target CSI transfer, or a proxy encoder-based monitoring.

In certain configurations, based on the monitoring of the estimated UL CSI, the base station sends a request for additional information to the UE. The base station then forwards the decision or request to the UE, and the UE follows the decision or replies to the request accordingly.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a base station, comprising:
receiving a sounding reference signal (SRS) from a user equipment (UE);
estimating an uplink (UL) channel state information (CSI) based on the received SRS;
monitoring the estimated UL CSI to track changes; and
determining whether to update or switch an artificial intelligence (AI)/machine learning (ML) model used for downlink (DL) CSI compression based on the monitoring of the estimated UL CSI.

2. The method of claim 1, wherein monitoring the estimated UL CSI comprises:
calculating one or more statistics of the estimated UL CSI; and
comparing the calculated one or more statistics to one or more previous statistics of a previously estimated UL CSI.

3. The method of claim 2, wherein the one or more statistics include at least one of:
a mean of elements in the estimated UL CSI; and
a variance of elements in the estimated UL CSI.

4. The method of claim 2, wherein determining whether to update or switch the AI/ML model comprises:
determining that the AI/ML model is to be updated or switched if a difference between the calculated one or more statistics and the one or more previous statistics exceeds a predefined threshold.

5. The method of claim 1, wherein monitoring the estimated UL CSI comprises:
calculating one or more metrics based on the estimated UL CSI; and
comparing the calculated one or more metrics to one or more previous metrics of a previously estimated UL CSI or one or more reference metrics.

6. The method of claim 5, wherein the one or more metrics include at least one of:
a historical entropy of the estimated UL CSI;
a power spectral entropy of the estimated UL CSI; or
a distance between the estimated UL CSI and one or more reference UL CSIs.

7. The method of claim 5, wherein determining whether to update or switch the AI/ML model comprises:
determining that the AI/ML model is to be updated or switched if a difference between the calculated one or more metrics and the one or more previous metrics or reference metrics exceeds a predefined threshold.

8. The method of claim 1, wherein monitoring the estimated UL CSI comprises:
inputting the estimated UL CSI into a hypothetical autoencoder to generate a reconstructed UL CSI; and
calculating a key performance indicator (KPI) based on the estimated UL CSI and the reconstructed UL CSI.

9. The method of claim 8, wherein the hypothetical autoencoder comprises a hypothetical encoder and a hypothetical decoder.

10. The method of claim 8, wherein the hypothetical autoencoder comprises a hypothetical encoder and an actual decoder used in CSI compression.

11. The method of claim 8, wherein the KPI comprises at least one of:
a normalized mean squared error (NMSE) between the estimated UL CSI and the reconstructed UL CSI;
a generalized cosine similarity (GCS) between the estimated UL CSI and the reconstructed UL CSI; or
a squared generalized cosine similarity (SGCS) between the estimated UL CSI and the reconstructed UL CSI.

12. The method of claim 8, wherein determining whether to update or switch the AI/ML model comprises:
determining that the AI/ML model is to be updated or switched if the calculated KPI falls below a predefined threshold.

13. The method of claim 1, further comprising:
triggering a DL CSI-based monitoring if the AI/ML model is to be updated or switched based on the monitoring of the estimated UL CSI.

14. The method of claim 13, wherein the DL CSI-based monitoring comprises at least one of:
a key performance indicator (KPI)-based monitoring with model transfer;
a KPI-based monitoring with target CSI transfer; or
a proxy encoder-based monitoring.

15. The method of claim 1, further comprising:
sending a request for additional information to the UE based on the monitoring of the estimated UL CSI.

16. An apparatus for wireless communication, the apparatus being a base station, comprising:
a memory; and
at least one processor coupled to the memory and configured to:
receive a sounding reference signal (SRS) from a user equipment (UE);
estimate an uplink (UL) channel state information (CSI) based on the received SRS;
monitor the estimated UL CSI to track changes; and
determine whether to update or switch an artificial intelligence (AI)/machine learning (ML) model used for downlink (DL) CSI compression based on the monitoring of the estimated UL CSI.

17. The apparatus of claim 16, wherein to monitor the estimated UL CSI, the at least one processor is further configured to:
calculate one or more statistics of the estimated UL CSI; and
compare the calculated one or more statistics to one or more previous statistics of a previously estimated UL CSI.

18. The apparatus of claim 17, wherein the one or more statistics include at least one of:
a mean of elements in the estimated UL CSI; and
a variance of elements in the estimated UL CSI.

19. The apparatus of claim 17, wherein to determine whether to update or switch the AI/ML model, the at least one processor is further configured to:
determine that the AI/ML model is to be updated or switched if a difference between the calculated one or more statistics and the one or more previous statistics exceeds a predefined threshold.

20. A computer-readable medium storing computer executable code for wireless communication of a base station, comprising code to:
receive a sounding reference signal (SRS) from a user equipment (UE);
estimate an uplink (UL) channel state information (CSI) based on the received SRS;
monitor the estimated UL CSI to track changes; and
determine whether to update or switch an artificial intelligence (AI)/machine learning (ML) model used for downlink (DL) CSI compression based on the monitoring of the estimated UL CSI.
